(19) United States
(12) Patent Application Publication
(10) Pub. No.: US 2013/0086036 A1
(43) Pub. Date: Apr. 4, 2013

(54) Dynamic Search Service

(71) Applicants: John Rizzo, Palo Alto, CA (US); Yessenzhar Kanapin, Palo Alto, CA (US); Jaehyun Park, Palo Alto, CA (US)

(72) Inventors: John Rizzo, Palo Alto, CA (US); Yessenzhar Kanapin, Palo Alto, CA (US); Jaehyun Park, Palo Alto, CA (US)

(21) Appl. No.: 13/600,701

(22) Filed: Aug. 31, 2012

Related U.S. Application Data
(60) Provisional application No. 61/530,135, filed on Sep. 1, 2011.

(51) Int. Cl. G06F 17/30

(52) U.S. Cl. CPC G06F 17/30864
USPC 707/709; 707/723

(57) ABSTRACT

Textual information processed by an application may be used to access data from one or more on-line data source (e.g., Wikipedia) which may be used to enhance the user experience or to improve user productivity from using the application. One such application may be a search service that accesses such data based on input data provided to the application. For example, the application may parse instant messages sent and received by a user to extract keywords, phrases or links, which are then used to retrieve information from a repository of data obtained form various data sources. In this manner, data related to the subject matters of the user's communication may be readily accessed by the user, if desired, in a convenient manner To deliver real time performance, the repository of data may be pre-processed (e.g., indexed) to facilitate information retrieval.

### CROSS REFERENCE TO RELATED APPLICATIONS

The present application is related to, and claims priority of, U.S. Provisional Patent Application, entitled “Dynamic Search Service,” Ser. No. 61/530,135, filed on Sep. 1, 2011 (“Provisional Patent Application”). The Provisional Patent Application is hereby incorporated by reference in its entirety.

### BACKGROUND OF THE INVENTION

1. Field of the Invention

The present invention is related to providing a search service to a user of an application that processes textual data. In particular, the present invention is related providing a search service which accesses multiple on-line data sources from a task bar, including both static and dynamic data sources (e.g., Rich Site Summary (RSS) data feeds), based in part on textual data processed, received or sent by a user of an application with on-line access.

2. Discussion of the Related Art

In some applications, such as those developed for instant messaging or blogging, a user often has a need to access data sources to obtain relevant information or to verify information received or to be sent out. For example, consider a professional discussion over instant messaging between two scientists, Alice and Bob. In the course of the discussion, Alice may realize that a scientific paper that she recently reviewed may be significant to the subject matter of her discussion with Bob. It would be tremendously helpful if the Alice can quickly access a copy of the scientific paper on-line, ascertain the relevance of the scientific paper to the subject matter at hand, and then share the scientific paper with Bob. In the prior art, Alice may switch from the instant messaging application to a browser. Alice would then point the browser to a search portal and initiate a search for the scientific paper using relevant keywords that identify the paper she wishes to access and locate the scientific paper from the search result. In the meantime, Alice's discussion with Bob is interrupted and Bob would have to wait for Alice to return after completing her search before the interrupted discussion may resume. The on-line discussion would be significantly enhanced if the interruption is minimized There is a significant need for a communication or productivity application that recognizes from the context and the content of a user's task and facilitates locating relevant information using that recognized context or content.

### SUMMARY

According to one embodiment of the present invention, textual information processed by an application may be used to access data from one or more on-line data source (e.g., Wikipedia) which may be used to enhance the user experience or to improve user productivity from using the application. In one embodiment, a search service accesses such data based on input data provided to the application. For example, the application may parse instant messages sent and received by a user to extract keywords, phrases or links, which are then used to retrieve information from a repository of data obtained form various data sources. In this manner, data related to the subject matters of the user's communication may be readily accessed by the user, if desired, in a convenient manner To deliver real time performance, the repository of data may be pre-processed (e.g., indexed) to facilitate information retrieval.

The present invention is better understood upon consideration of the detailed description below and the accompanying drawings.

### BRIEF DESCRIPTION OF THE DRAWINGS

FIG. 1 shows an on-screen graphical user interface (in the form of a task bar) based on SmartBar 202, according to one embodiment of the present invention.

FIG. 2 is a block diagram showing the data processing activities in one dynamic search application, in accordance with one embodiment of the present invention.

### DETAILED DESCRIPTION OF THE PREFERRED EMBODIMENTS

The present invention is applicable to any interactive or dynamic application, such as an instant message service or a blogging tool, in which a user both receives and sends textual information. According to one embodiment of the present invention, such textual information may be used by an application to access data from one or more on-line data source (e.g., Wikipedia, an e-commerce website, or an RSS feed) which may be used to enhance the experience or improve productivity from using the application. In one embodiment, a search service accesses such data sources based on input data provided to the application. For example, the application may parse instant messages sent and received by a user to extract keywords, phrases or links, which are then used to retrieve information from a repository of data obtained form various data sources. In this manner, data related to the subject matters of the user's communication may be readily accessed by the user, if desired, in a convenient manner To deliver real time performance, the repository of data may be pre-processed (e.g., indexed) to facilitate information retrieval. Such a search service is not limited exclusively to relatively static textual data (i.e., textual data that is not expected to change in the duration of the user's session of the application). By suitably pre-processing time-sensitive data using an appropriate schedule, together with a selection and discard policy, easy and real time access to dynamically changing data (e.g., “tweets” and RSS data feeds) may be provided. The present invention provides access also to non-textual data (e.g., video or photographs).

In one embodiment, search options and search results may be presented to a user of an application in the form of a task bar. In that embodiment, in which the application handles instant messages, the task bar is a user interface to a dynamic search service which takes advantage of a user's instant messages and shows relevant information that is selected based on the content of the instant messages. FIG. 2 is a block diagram showing the data processing activities in one such dynamic search service, in accordance with one embodiment of the present invention.

As shown in FIG. 2, the operations of the dynamic search service are included in separately-handled pre-processing and query phases. In the preprocessing phase, a data gathering process (“crawler” 206) accesses various data sources at appropriate time intervals to collect data of selected topics of interest from the data sources. Crawler 206 may include one or more programs running on one or more servers on a wide area network,. Crawler 206 may retrieve data, for example, from a Wikipedia “dump” (i.e., a snapshot of all articles under Wikipedia). Crawler 206 may also access to more dynamic data sources, such as RSS news feeds, and short articles (i.e., those articles popularly known as “tweets”). The collected data can then be processed, analyzed, indexed and stored in database 209. In some embodiments, crawler 206 may include programs that are each customized to comb a particular type of data source, for example. The dynamic search service of the present invention may be extended to process or other types of data, e.g., photographs and videos, as well as large, almost-static data, such as the world wide web. For example, for access to time-sensitive data (e.g., news articles), the dynamic search service may retrieve data from a data repository that includes only news articles that are made available within a dynamically moving time window (e.g., last 24 hours). In the following detailed description, Wikipedia is used as an example to illustrate the techniques used in the dynamic search service. Techniques specific to more dynamic data sources or to other types of non-textual information can be applied in the dynamic search service according to the principles discussed herein.

In one embodiment, items that are stored in database 209 are organized as “smartbites.” Each smartbite is an item (e.g., an indexed wikipedia page) that is indexed by keywords or phrases found within the smartbite, or by one or more classifications given to the smartbite. As shown in FIG. 2, crawler 206 sends candidate smartbite items to “TermAggregator” 203, which is a process which analyzes the textual content in each candidate smartbite item. Typical processing may include, for example, tokenizing the text in the candidate item, identifying keywords, key phrases or links of significance, computing the frequencies for the keywords or key phrases identified, and identifying other candidate smartbite items linked to the candidate smartbite item. The candidate smartbite items are also processed for quality in storage process 204. Candidate smartbite items that are not rejected are analyzed for quality. Different analysis techniques may be applied by storage process 204, as appropriate, to the different data sources or the different data types. For example, for news articles retrieved from, for example, a frequently updated news site, applicable quality measures may include “freshness” (i.e., how recently a given news article was updated), the number of reposts that have occurred within a recent predetermined time window and other indicia of timeliness. As another example, a wikipedia article may be analyzed for quality based on the number of citations by other smartbite items, by its popularity (e.g., as measured by its hit statistics, if available), or any other suitable indicia of quality. As a further example, for candidate smartbite items from an e-commerce website (e.g., merchandise listed on sites, such as amazon.com), such candidate smartbite items may be analyzed and categorized, for example, by user ratings in product reviews. Accesses to images and videos may require recognition and search of descriptive data associated with such items.

After storage process 204 has processed and analyzed each candidate smartbite item, storage process 204 assigns to the candidate smartbite item search keys, key phrases or categories for indexing, and calls upon a database management program (e.g., DBPlus) to store the candidate smartbite item as a smartbite in database 207. As shown in FIG. 2, database 207 may be replenished and indexed periodically (e.g., every 30 minutes) to maintain currency for time-sensitive smartbites. The pre-processing phase also provides IconStore 205, which is a process provided to manage images (i.e., store and serve images) associated with smartbites. These images are typically displayed to a client along with snippets of the associated smartbites.

For relatively static data sources, such as Wikipedia, the pre-processing phase may be executed less frequently than more dynamic data sources. As the preprocessing phase is executed infrequently, data storing and processing may be carried out locally. The indexing step in storage process 204 is intended to facilitate data retrieval during the query phase.

Indexing may also create several files for different statistics collected on the data. For data received from Wikipedia, for example, statistics collected may be the size of each article, the number of words appearing in each article, and identification of words or phrases that occur more frequently than a predetermined threshold frequency. In particular, for each word that appears at least once across all the Wikipedia articles collected, the articles that contain the word are recorded, as well as the total number of occurrences. Such statistical data is useful for identifying candidate words to be used as keywords that allow retrieval during the query phase or for retrieving related information from other data sources. For example, as the word “BMW” appears less frequently than the word “car,” “BMW” is thus more specifically indicative of the desired subject matter and thus a better keyword to be used for retrieving related information . On the other hand, words like “it” or “the” appear in practically every article, so they are not good indicators for a specific topic.

The query phase typically begins operation when an application (e.g., client program 201) starts up. In an instant messaging application, for example, an application program of the dynamic search service (e.g., “SmartBar” 202) extracts keywords or key phrases from the instant messages entered by the user or received from incoming messages to retrieve relevant information from the repository of the preprocessed data. The operations of the preprocessing step (e.g., the indexing) assist in efficiently retrieve data (e.g., Wikipedia articles) that are relevant to the users' current conversations. In one embodiment, during the query phase, a number of most recent messages of a conversation are stored in a buffer. The content of the buffer is then broken into individual words to make a bag of words. In this process, common words are removed in order to enhance the quality of the search results.

Next, SmartBar 202 requests storage process 204 to retrieve from database 207 all the smartbites that contain at least one of the words in this bag of words. The retrieved smartbites (e.g., Wikipedia articles) are then scored by storage process 204. A few of the smartbites with the highest scores are returned to the user. The returned smartbites may be shown, for example, on a task bar provided at a convenient position in the user interface.

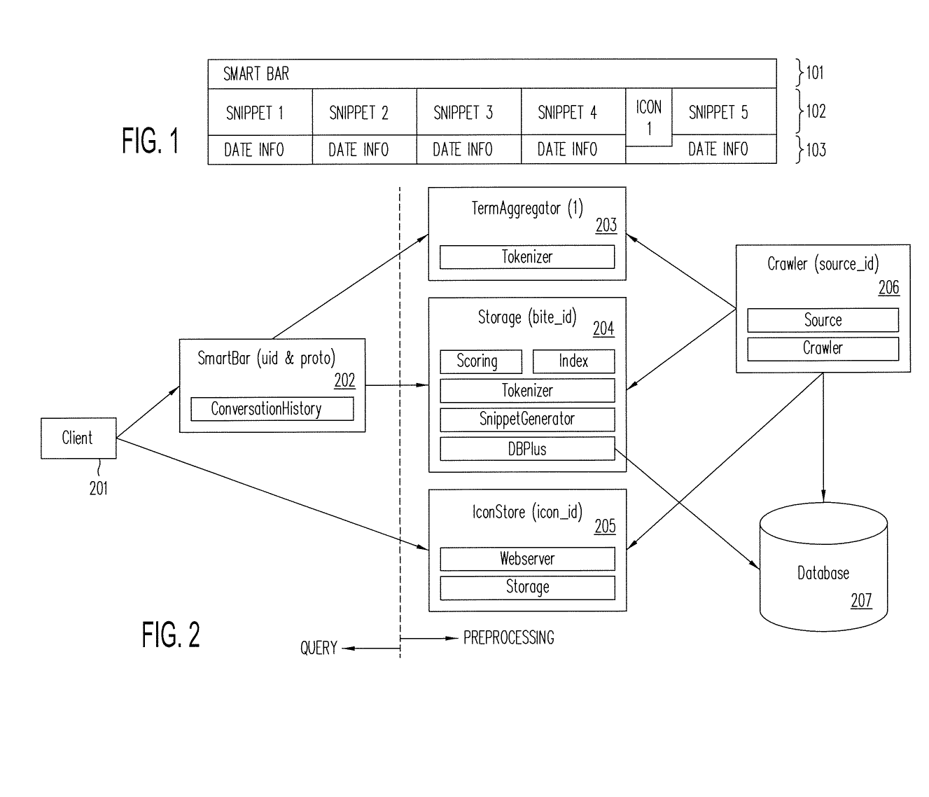

FIG. 1 shows an on-line graphical user interface in the form of task bar 100 provided by Smart Bar 202, according to one embodiment of the present invention. As shown in FIG. 1, task bar 100 shows snippets 1-5 of 5 smartbites in the portion labeled 102, representing online materials that are relevant to the current topic of the conversation, typically at the bottom of the graphical display. Each of snippets 1-5 is also associated with date information (labeled 103 in FIG. 1) to inform the user the timeliness of the associated smartbite (e.g., updated within the last 5 days). Associated with each smartbite may be an icon or image, such as icon 1 shown next to snippet 5 of FIG. 1. In the portion labeled 101 of task bar 100 are various options of user commands handled by SmartBar 202 that are made available to the user. In one embodiment, a user may decide not to use the search service by minimizing task bar 100, Minimizing task bar 100 disables the search service from analyzing a user's conversations

In one embodiment, the scoring of smartbites in storage process 204 are carried out in the following manner First, from the statistics on the number of occurrences of each word, an inverse document frequency (IDF) weight is calculated for the word. The IDF weight is explained, for example, at the webs page http://en.wikipedia.org/wiki/Tf%E2%80%93idf. Each word in a smartbite that matches a word in the word bag contributes to the article's score. The word contributes a predetermined number of points that is proportional to its IDF weight. Compound words (i.e., multi-word terms, or key phrases, such as “black list”) are also taken into account. For example, if a user enters the two-word term “Harry Potter,” then smartbites containing such a term is weighted more heavily than smartbites containing “Harry” and “Potter” separately. In addition, heuristics may be used to filter out smartbites that satisfy certain specified conditions. For example, one filtering condition may be smartbites that contain an unusual number of occurrences of a single word, or smartbites that are too short.

After selecting the smartbites to show the user, an additional step may be performed. In this additional step, a snippet that is deemed most relevant to the current conversation (or user input) is extracted from each selected smartbites. To extract the snippet, all substrings within an article or within a user input string that are longer than a fixed size are identified and each word within each identified substring is scored. The scoring of a word depends on two factors: (1) the frequency of the word within the entire article, (2) where the word occurs within the substring.

The search service of the present invention may be implemented, for example, using the programming language C++, which is deemed an efficient programming language. A Python wrapper may be added to allow the search service to work seamlessly with an application (e.g., an imo.im application).

The detailed description above is provided to illustrate the specific embodiments of the present invention and is not intended to be limiting. Numerous modifications and variations within the scope of the present invention are possible. The present invention is set for in the accompanying claims.

We claims:

1. A method for enabling a dynamic search in an application that processes messages received from or sent to a user, comprising:
providing a database that contains a collection of data records retrieved from a plurality of data sources;
extracting from the messages in real time, as messages are received from the user or sent to the user, a plurality of keywords based on an analysis of the subject matters included in the messages;
retrieving from the database data records based on the selected keywords or key phrases;
assigning a score to each selected data record based on a scoring function;
ranking the selected data records according their respective scores; and
reporting a subset of the selected data records, the reported data records being included in the subset according to the ranking

2. The method of claim 1, wherein providing the database comprises:
providing one or more data crawling programs running on a server on the wide area network, each data crawling program retrieving data from one or more of the data sources according to a predetermined schedule;
processing the data retrieved from the data sources into data records of a predetermined format;
indexing the processed data records for search using keywords included in each data record; and
storing the indexed data record in the database.

3. The method of claim 2, wherein the data sources being selected from the group consisting of news feed sites, e-commerce sites, and on-line encyclopedia sites.

4. The method of claim 2, wherein the data sources encompass all sites on the world wide web.

5. The method of claim 2, wherein processing the data retrieved from the data sources comprises separately indexing and storing icons or images in the data retrieved from data sources.

6. The method of claim 5, further comprising creating snippets from each data record and associating each snippet with the data record from which the snippet is created.

7. The method of claim 1, further comprising providing a tool bar as a graphical interface for displaying the reported data records.

8. The method of claim 2, wherein the predetermined schedules are selected according to the content provided by the associated data sources.

9. The method of claim 2, further comprising compiling statistics of each data record based on one or more of: a size of the data record, the number of words appearing in the data record, and identification of words that occur more frequently than a predetermined threshold frequency.
